(19) United States
(12) Patent Application Publication
(10) Pub. No.: US 2008/0180615 A1
(43) Pub. Date: Jul. 31, 2008

(54) LIQUID CRYSTAL DISPLAY DEVICE AND ELECTRONIC APPARATUS

(75) Inventor: Akihide HARUYAMA, Fujimi-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/947,309

(22) Filed: Nov. 29, 2007

(30) Foreign Application Priority Data
Jan. 25, 2007 (JP) 2007-014904

(51) Int. Cl. G02F 1/1335

(52) U.S. Cl. 349/114

(57) ABSTRACT

Disclosed is a liquid crystal display device that performs initial transition before display operation from splay alignment of liquid crystal to bend alignment. The liquid crystal display device includes a first substrate, a second substrate, and a liquid crystal layer between the first and second substrates. In the display device, a transmissive display area, a first sub-reflective-display area and a second sub-reflective-display area are arranged in each sub-pixel region. The thickness of the liquid crystal layer In the transmissive display area is made different from that in the reflective display area. The transmissive display area is disposed between the first sub-reflective-display area and the second sub-reflective-display area.

### BACKGROUND

1. Technical Field

The present invention relates to a liquid crystal display device and an electronic apparatus.

2. Related Art

Transflective liquid crystal display devices have been used as display units in portable electronic apparatuses. Recently, Transflective liquid crystal display devices operable in an optically compensated bend (OCB) mode providing high response speed have been developed in order to improve the quality of moving images, as disclosed in Japanese Unexamined Patent Application Publication Nos. 2005-352134 (Patent Document 1), 2006-113259 (Patent Document 2), and 2006-285128 (Patent Document 3).

In a liquid crystal display device disclosed in Patent Document 1, a multi-gap structure is provided in a layer under reflecting electrodes and the pretilt angle of liquid crystal is controlled at or above 10°. In another liquid crystal display device disclosed in Patent Document 2, projections for causing initial transition are disposed in each light transmitting portion and depressions for causing initial transition are arranged in each light reflecting portion in a multi-gap structure. In further another liquid crystal display device disclosed in Patent Document 3, an insulating layer is arranged on electrodes in light reflecting portions to match the transmittance versus voltage (T-V) characteristic of a transmissive display mode with that of a reflective display mode. The arrangement of the insulating layer also planarizes the light reflecting portions.

The liquid crystal display devices disclosed in Patent Documents 1 to 3 are of the transflective type operable in the OCB mode. Propagating initial transition from splay alignment to bend alignment necessary for an OCB-mode liquid crystal display device is of extreme importance for the use of the liquid crystal display device and the display quality. Disadvantageously, the above-described propagation is hardly considered in the liquid crystal display devices disclosed in Patent Documents 1 to 3. In each of those related-art liquid crystal display devices, time required for transition increases and an operation of causing initial transition (hereinafter, referred to as “initial transition operation”) is insufficiently performed. Unfortunately, a display defect may occur when the display device is in use.

An advantage of some aspects of the invention is to provide a transflective liquid crystal display device capable of rapidly performing initial transition from splay alignment to bend alignment with a low voltage.

According to an aspect of the invention, a liquid crystal display device that performs initial transition before display operation from splay alignment of liquid crystal to bend alignment includes a first substrate and a second substrate, and a liquid crystal layer between the first and the second substrates. In the liquid crystal display device, a transmissive display area, a first sub-reflective-display area and a second sub-reflective-display area are arranged in each sub-pixel region. The first sub-reflective-display area and the second sub-reflective-display area form reflective display area. The thickness of the liquid crystal layer in the transmissive display area is made different from that in the reflective display area. The transmissive display area is disposed between the first sub-reflective-display area and the second sub-reflective-display area.

The liquid crystal display device according to this aspect is of the transflective type having a multi-gap structure in which the thickness of the liquid crystal layer is partially varied in each sub-pixel region. In this liquid crystal display device, since the thickness of the liquid crystal layer in the reflective display area is thinner than that in the transmissive display area, an electric field affecting the liquid crystal layer in the reflective display area is stronger than that in the transmissive display area. Consequently, when a voltage is applied to the liquid crystal layer upon initial transition operation, an initial transition nucleus (bend nucleus) is more easily generated in the reflective display area than in the transmissive display area. In addition, the initial transition nucleus can be smoothly propagated.

According to this aspect, in consideration of the above-described characteristics of the reflective display area, the transmissive display area is disposed between the first sub-reflective-display area and the second sub-reflective-display area. Further, the sub-reflective-display area is arranged near signal lines, such as a scan line and a data line, serving as an area where an initial transition nucleus is generated upon initial transition operation.

Consequently, the initial transition nucleus generated near each sub-pixel region can be smoothly introduced into the reflective display area.

Furthermore, the initial transition nucleus can be smoothly propagated in the reflective display area.

According to the liquid crystal display device of this aspect, the initial transition can be rapidly propagated uniformly in the whole of each sub-pixel region. A display defect caused by insufficient initial transition can be prevented.

Preferably, the liquid crystal display device further includes a layer-thickness adjusting layer for adjusting the thickness of the liquid crystal layer. The layer-thickness adjusting layer is arranged in at least one of the first and the second substrates adjacent to the liquid crystal layer such that the layer-thickness adjusting layer extends above the reflective display areas of two neighboring sub-pixel regions.

With this arrangement, the thickness of the liquid crystal layer in each portion between neighboring sub-pixel regions is equal to that in the reflective display area. Accordingly, an initial transition nucleus is easily generated in this portion similar to the reflective display area and the initial transition nucleus is smoothly propagated. The generation of initial transition nuclei near the sub-pixel regions is accelerated, so that the initial transition operation can be rapidly performed with reliability.

Preferably, one of the first and the second substrates includes signal lines electrically connected to switching elements arranged so as to correspond to the respective sub-pixel regions, and the other substrate includes a layer-thickness adjusting layer adjacent to the liquid crystal layer. In other words, it is preferable that the layer-thickness adjusting layer be not arranged in the substrate including the signal lines.

With this arrangement, the distance between the liquid crystal layer and the signal lines, functioning as a transition-nucleus generating mechanism in a device substrate, or the switching elements is reduced, so that initial transition nuclei can be efficiently generated.

Preferably, the firsts sub-reflective-display area is arranged in one end of the sub-pixel region in the lengthwise direction thereof, and the second sub-reflective-display area is arranged in another end of the sub-pixel region which is opposite to the one end of the sub-pixel region.

With this arrangement, initial transition can be propagated from both the ends of each sub-pixel region in the lengthwise direction. Advantageously, the initial transition can be advanced uniformly in the whole of each sub-pixel region.

The liquid crystal display device according to this aspect may further include a transition-nucleus generating mechanism arranged in the reflective display area.

With the arrangement of the transition-nucleus generating mechanism in the reflective display area, an initial transition nucleus can be more smoothly generated and propagated as compared to arrangement of the transition-nucleus generating mechanism in the transmissive display area.

The liquid crystal display device according to this aspect may further include a transition-nucleus generating mechanism arranged in a portion between the reflective display area and the transmissive display area.

In the liquid crystal display device having a multi-gap structure, since the thickness of the liquid crystal layer gradually varies in the portion between the reflective display area and the transmissive display area, the alignment of liquid crystal is easily disordered in that portion. The arrangement of the transition-nucleus generating mechanism in the portion allows an initial transition nucleus to be more reliably generated.

The liquid crystal display device according to this aspect may further include a transition-nucleus generating mechanism arranged in a portion between neighboring sub-pixel regions.

With the arrangement of the transition-nucleus generating mechanism in the portion between neighboring sub-pixels near the reflective display areas, initial transition generated by the transition-nucleus generating mechanism can be easily propagated in the reflective display areas.

Preferably, the transition-nucleus generating mechanism is a signal line electrically connected to a switching element arranged so as to correspond to the sub-pixel region, or an electrode disposed so as to correspond to the sub-pixel region. In other words, a section capable of applying a desired voltage to the liquid crystal layer may be used as a transition-nucleus generating mechanism.

The transition-nucleus generating mechanism may be a domain, where the alignment state of liquid crystal is made different from that in the sub-pixel, in the liquid crystal layer.

With the arrangement of the domain where the alignment state of liquid crystal is made different from that in the sub-pixel, a disclination is easily generated at the interface between liquid crystal in the domain and that in the sub-pixel. Since the disclination serves as an initial transition nucleus, the initial transition operation can be reliably performed in a short time.

In the domain having the different alignment state, liquid crystal molecules in the liquid crystal layer may be aligned in homeotropic alignment. Alternatively, liquid crystal molecules in the domain in the liquid crystal layer may be aligned in twisted alignment. In either alignment state in the liquid crystal display device, initial transition can be easily propagated in each sub-pixel region.

The transition-nucleus generating mechanism may be a spacer for maintaining the spacing between the first and the second substrates. In the vicinity of the spacer, liquid crystal molecules tend to be easily aligned in random directions, so that an initial transition nucleus is easily generated. The spacer may be used as a transition-nucleus generating mechanism.

According to another aspect of the invention, an electronic apparatus includes the liquid crystal display device according to the foregoing aspect of the invention. With this structure, the occurrence of a display defect caused by an insufficient initial transition operation can be effectively prevented. Advantageously, the electronic apparatus having a display unit capable of displaying a high quality image at a high response speed can be provided.

### BRIEF DESCRIPTION OF THE DRAWINGS

The invention will be described with reference to the accompanying drawings, wherein like numbers reference like elements.

FIG. 1A is a diagram illustrating a liquid crystal display device according to a first embodiment of the invention.

FIG. 1B is a cross-sectional view of the liquid crystal display device taken along the line IB-IB of FIG. 1A.

FIG. 2 is an equivalent circuit diagram of the liquid crystal display device according to the first embodiment.

FIG. 3 is a plan view of a single sub-pixel region of the liquid crystal display device according to the first embodiment.

FIG. 4 is a cross-sectional view of the liquid crystal display device taken along the line IV-IV of FIG. 3.

FIGS. 5A and 5B are diagrams explaining alignment states of liquid crystal.

FIG. 6 is a plan view of sub-pixel regions of a liquid crystal display according to a second embodiment of the invention.

FIG. 7 is a cross-sectional view of the liquid crystal display device taken along the line VII-VII of FIG. 6.

FIG. 8 is a plan view of part of a single sub-pixel region of a liquid crystal display device according to a third embodiment of the invention.

FIG. 9 is a perspective view of an electronic apparatus.

### DESCRIPTION OF EXEMPLARY EMBODIMENTS

Embodiments of the present invention will be described below with reference to the drawings.

In the drawings used in the following description, the scale of components is appropriately changed so that each component has a perceptible size.

### First Embodiment

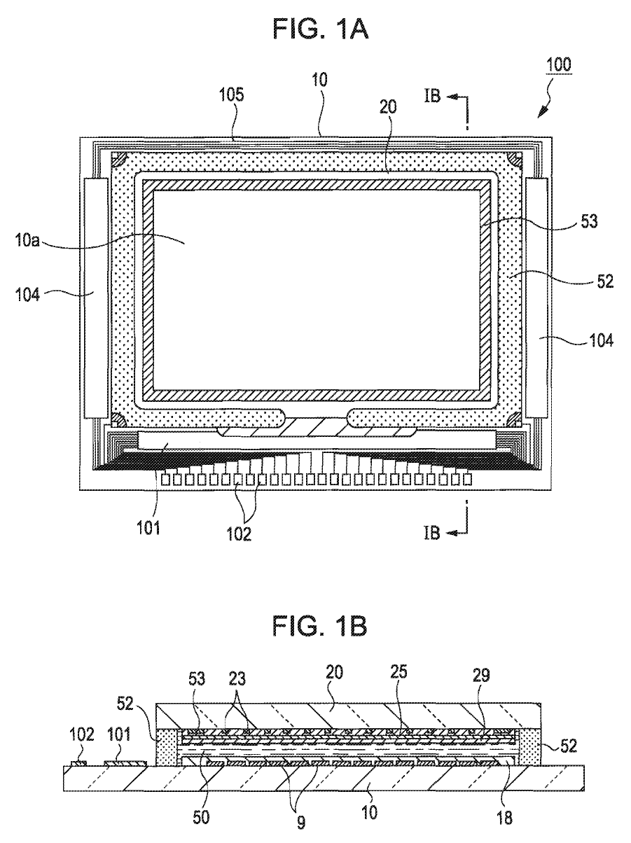

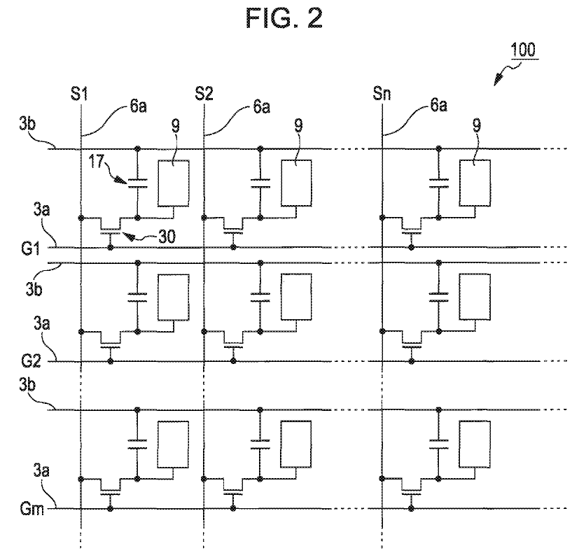

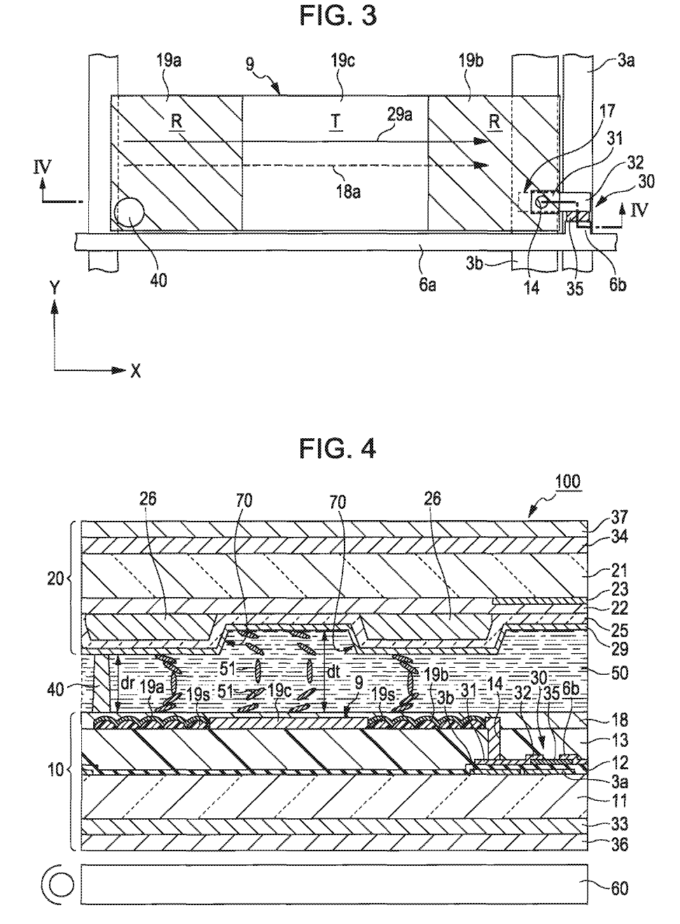

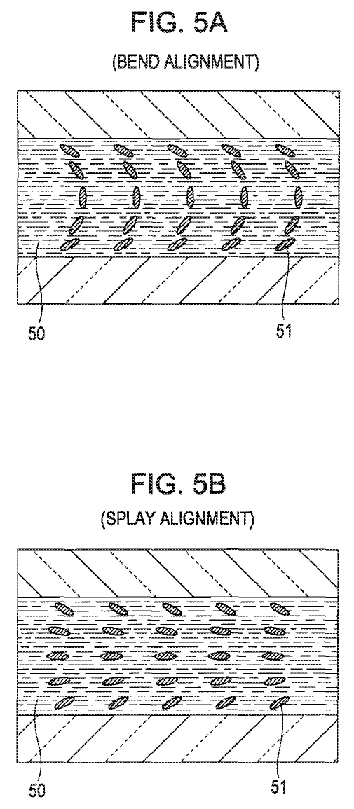

FIG. 1A is a plan view of a liquid crystal display device 100 according to a first embodiment of the invention. FIG. 1B is a cross-sectional view of the liquid crystal display device taken along the line IB-IB of FIG. 1A. FIG. 2 is an equivalent circuit diagram of the liquid crystal display device. FIG. 3 is a plan view of the structure of a single sub-pixel region. FIG. 4 is a cross-sectional view of the liquid crystal display device taken along the line IV-IV of FIG. 3. FIGS. 5A and 5B are schematic diagrams illustrating alignment states of liquid crystal molecules.

The liquid crystal display device 100 according to the first embodiment is of the active matrix transmissive type. In the liquid crystal display device 100, three sub-pixels for outputting red (R), green (G), and blue (B) light beams constitute a single pixel. In this description, a display area as a minimum display unit will be termed “sub-pixel region” and a display area composed of three sub-pixels will be called “pixel region”.

Referring to FIGS. 1A and 1B, the liquid crystal display device 100 includes a device substrate (first substrate) 10, an opposite substrate (second substrate) 20 opposite to the device substrate 10, and a liquid crystal layer 50 arranged between the device substrate 10 and the opposite substrate 20. In the liquid crystal display device 100, a seal 52 joins the device substrate 10 to the opposite substrate 20 to enclose the liquid crystal layer 50 within a region surrounded by the seal 52. A peripheral partition 53 is arranged along the inner periphery of the seal 52. An area, which is rectangular when viewed in plan (i.e., when the device substrate 10 is viewed from the side of the opposite substrate 20), surrounded by the peripheral partition 53 serves as an image display area 10a. The liquid crystal display device 100 further includes a data line driving circuit 101, scan line driving circuits 104, connecting terminals 102 in conduction with the data line driving circuit 101 and the scan line driving circuits 104, and lines 105 connecting the scan line driving circuits 104. The data line driving circuit 101 and the scan line driving circuits 104 are arranged outside the seal 52.

Referring to FIG. 2, a plurality of sub-pixel regions are arranged in a matrix form when viewed in plan in the image display area 10a of the liquid crystal display device 100. A pixel electrode 9 and a thin film transistor (TFT) 30 for controlling the switching operation of the pixel electrode 9 are arranged so as to correspond to each sub-pixel region. In the image display area 10a, a plurality of data lines 6a and a plurality of scan lines 3a are arranged in a lattice form.

The source of each TFT 30 is electrically connected to the corresponding data line 6a, the gate thereof is electrically connected to the corresponding scan line 3a, and the drain thereof is electrically connected to the corresponding pixel electrode 9. The data lines 6a are connected to the data line driving circuit 101. Image signals S1, S2, . . . , and Sn supplied from the data line driving circuit 101 are supplied to the respective sub-pixel regions through the data lines 6a. The scan lines 3a are connected to the scan line driving circuits 104. Scan signals G1, G2, . . . , and Gm input from the scan line driving circuits 104 are supplied to the respective sub-pixel regions through the scan lines 3a.

The image signals S1 to Sn input from the data line driving circuit 101 to the data lines 6a may be line-sequentially supplied in that order. Alternatively, a set of image signals may be supplied to each group of neighboring data lines 6a. The scan line driving circuits 104 line-sequentially supply the scan signals G1 to Gm to the scan lines 3a with predetermined timing in accordance with pulses.

In the liquid crystal display device 100, the TFTs 30, each serving as a switching element, are turned on for a predetermined period when receiving the scan signals G1 to Gm, so that the image signals S1 to Sn supplied from the data lines 6a are written into the pixel electrodes 9 with predetermined timing. The image signals S1 to Sn, each having a predetermined level, written in liquid crystal through the pixel electrodes 9 are held between the pixel electrodes 9 and a common electrode opposite to the pixel electrodes 9 with the liquid crystal layer 50 therebetween for a predetermined period. The common electrode will be described later.

To prevent leakage of the held image signals S1 to Sn, a storage capacitor 17 is arranged in parallel to a liquid crystal capacitor formed between the pixel electrode 9 and the common electrode in each sub-pixel region. The storage capacitor 17 is connected between the drain of the TFT 30 and a capacitor line 3b.

The detailed structure of the liquid crystal display device 100 will now be described with reference to FIGS. 3 and 4. An FIG. 3, the X-axis direction and the Y-axis direction are defined as follows: The direction along the length of the sub-pixel region, which is substantially rectangular when viewed in plan, the direction along the length of the pixel electrode 9, and the direction in which the data line 6a extends is the X-axis directions. The direction along the width of the sub-pixel region, the direction along the width of the pixel electrode 9, the direction in which the scan line 3a extends, and the direction in which the capacitor line 3b extends is the Y-axis direction.

Referring to FIG. 4, the liquid crystal display device 100 includes the device substrate 10, the opposite substrate 20, the liquid crystal layer 50 arranged between the substrates 10 and 20, a first retardation film 33, a first polarizer 36, a second retardation film 34, a second polarizer 37, and a lighting system 60. The first retardation film 33 and the first polarizer 36 are arranged in sequence on the outer surface of the device substrate 10 remote from the liquid crystal layer 50. The second retardation film 34 and the second polarizer 37 are arranged in sequence on the outer surface of the opposite substrate 20 remote from the liquid crystal layer 50. The lighting system 60 for emitting illumination light is opposite to the first polarizer 36. The liquid crystal layer 50 is operated in the OCB mode. During the operation of the liquid crystal display device 100, liquid crystal molecules 51 are aligned in bend alignment such that the molecules are aligned so as to form substantially arches as shown in FIG. 4.

Referring to FIG. 3, the pixel electrode 9, which is long along one direction (the X-axis direction) and is rectangular when viewed in plan, is arranged in each sub-pixel region. The data line 6a extends along one long side of the pixel electrode 9 and the scan line 3a extends along the short side thereof. The capacitor line 3b is arranged in parallel to the scan line 3a so as to overlap the pixel electrode 9.

The pixel electrode 9 includes two reflecting electrodes 19a and 19b and a transparent electrode 19c which are arranged in sequence along the lengthwise direction of the sub-pixel region so as to partition the sub-pixel region. The reflecting electrodes 19a and 19b and the transparent electrode 19c are electrically connected to each other. The reflecting electrodes 19a and 19b are arranged on both ends of the sub-pixel region in the lengthwise direction thereof. The transparent electrode 19c is arranged between the reflecting electrodes 19a and 19b. In the first embodiment, portions where the reflecting electrodes 19a and 19b are arranged serve as the first sub-reflective-display area R and the second sub-reflective-display area R that reflect light incident from the outside to perform display. A portion where the transparent electrode 19c is arranged serves as a transmissive display area T that uses illumination light coming from the lighting system 60 to perform display.

The reflecting electrodes 19a and 19b each include a light-reflective metal layer, such as an aluminum layer or a silver layer. The transparent electrode 19c includes a transparent conducting layer made of, for example, indium tin oxide (ITO)

The reflecting electrode 19b two-dimensionally overlaps the capacitor line 3b, whereas the reflecting electrode 19a two-dimensionally overlaps the scan line 3a in the adjacent sub-pixel region. In an area where the reflecting electrode 19b two-dimensionally overlaps the capacitor line 3b, a connecting portion for connecting the pixel electrode 9 to the TFT 30 is arranged. In an area corresponding to the reflecting electrode 19a, a spacer 40 for maintaining the spacing between the device substrate 10 and the opposite substrate 20 (i.e., the thickness of the liquid crystal layer 50) constant is arranged in the vicinity of the intersection of the scan line 3a and the data line 6a.

The TFT 30, serving as a switching element, is arranged above the scan line 3a. The TFT 30 includes a semiconductor layer 35, a source electrode 6b, and a drain electrode 32. The semiconductor layer 35 includes an island-shaped amorphous silicon layer. The source electrode 6b and the drain electrode 32 overlap the semiconductor layer 35. A portion of the scan line 3a two-dimensionally overlapping the semiconductor layer 35 functions as the gate electrode of the TFT 30.

End part of the source electrode 6b remote from the semiconductor layer 35 is connected to the data line 6a. The end of the drain electrode 32 remote from the semiconductor layer 35 constitutes a capacitor electrode 31. The capacitor electrode 31 is arranged above the capacitor line 3b, so that the storage capacitor 17 using the capacitor electrode 31 and the capacitor line 3b as electrodes is provided. When the pixel electrode 9 is electrically connected to the capacitor electrode 31 through a pixel contact hole 14 arranged on the capacitor electrode 31, the drain of the TFT 30 is brought into conduction with the pixel electrode 9.

Referring to FIG. 4, the device substrate 10 includes a base 11 made of a light-transmissive material, such as glass, quartz, or plastic. On the inner surface of the base 11 adjacent to the liquid crystal layer 50, the scan line 3a and the capacitor line 3b are arranged. In addition, a gate insulating layer 12, the semiconductor layer 35, the source electrode 6b (the data line 6a), the drain electrode 32, and the capacitor electrode 31 are arranged. The gate insulating layer 12 covers the scan line 3a and the capacitor line 3b. The semiconductor layer 35 is opposite to the scan line 3a with the gate insulating layer 12 therebetween. The source electrode 6b is connected to the semiconductor layer 35. The capacitor electrode 31 is connected to the drain electrode 32 and is opposite to the capacitor line 3b with the gate insulating layer 12 therebetween. In other words, the TFT 30 and the storage capacitor 17 connected thereto are arranged above the base 11.

A planarizing layer 13 for covering protrusions and depressions, caused by the TFT 30, on the base 11 is arranged. The pixel contact hole 14 is arranged so as to pass through the planarizing layer 13 and reach the capacitor electrode 31. The pixel electrode 9 arranged on the planarizing layer 13 is electrically connected to the capacitor electrode 31 through the pixel contact hole 14.

A resin layer 19s having an uneven surface is arranged between the planarizing layer 13 and each of the reflecting electrodes 19a and 19b constituting the pixel electrode 9. The reflecting electrodes 19a and 19b arranged on the resin layer 19s also each have an uneven surface similar to the uneven surface of the resin layer 19s. Consequently, the reflecting electrodes 19a and 19b each function as a reflective scattering layer for reflecting incident light while scattering the light.

An alignment layer 18 is arranged so as to cover the pixel electrode 9. The alignment layer 18 is composed of, for example, polyimide. The alignment layer 18 is rubbed in the lengthwise direction of the sub-pixel region (in the X-axis direction). The alignment layer 13 allows the liquid crystal molecules 51 to align along an alignment direction 18a indicated by the dashed arrow in FIG. 3.

The opposite substrate 20 includes a base 21 made of a light-transmissive material, such as glass, quartz, or plastic. On the inner surface of the base 21 adjacent to the liquid crystal layer 50, a light-shielding layer (black matrix) 23 and a color filter 22 are laminated. The light-shielding layer 23 is arranged so as to surround each sub-pixel region. The color filter 22 includes color material segments of different three colors corresponding to the sub-pixel regions. On the color filter 22, a layer-thickness adjusting layer 26 for partially changing the thickness of the liquid crystal layer in the sub-pixel region is arranged in each area (sub-reflective-display area R) which two-dimensionally overlaps the reflecting electrode 19a or 19b in the device substrate 10. The surface of the color filter 22 on which the layer-thickness adjusting layer 26 is arranged may be planarized by a planarizing layer made of, for example, a resin material.

A common electrode 25 made of a transparent conducting material, such as ITO, is arranged so as to cover the layer-thickness adjusting layer 26 and the color filter 22. The common electrode 25 covers the whole of sub-pixel regions. The common electrode 25 is covered with an alignment layer 29 made of polyimide. The surface of the alignment layer 29 is rubbed in the lengthwise direction of the sub-pixel region (in the X-axis direction. The alignment layer 29 allows the liquid crystal molecules 51 to align along an alignment direction 29a indicated by the solid arrow in FIG. 3.

According to the first embodiment, the liquid crystal display device 100, which includes the sub-reflective-display areas R and the transmissive display area T in each sub-pixel region, is of the transflective type. The liquid crystal display device 100 has a multi-gap structure in which the layer-thickness adjusting layer 26 is arranged above each sub-reflective-display area R. Since the layer-thickness adjusting layer 26 adjusts the thickness of the liquid crystal layer 50, the thickness dr of the liquid crystal layer in each sub-reflective-display area R is less than the thickness dt of the liquid crystal layer in each transmissive display area T. The thickness dr in each sub-reflective-display area R is approximately ½ the thickness dt in each transmissive display area T. The use of the multi-gap structure allows the liquid crystal layer 50 in each sub-reflective-display area R to have substantially the same retardation as that of the liquid crystal layer 50 in each transmissive display area T. Consequently, an image segment can be displayed uniformly in the sub-reflective-display areas R and the transmissive display area T of each sub-pixel region.

The first and second polarizers 36 and 37 are arranged such that the transmission axes of the polarizers are substantially orthogonal to each other. The first retardation film 33 on the inner surface of the first polarizer 36 and the second retardation film 34 on the inner surface of the second polarizer 37 are λ/4 retardation films for giving a phase shift of approximately ¼ wavelength to transmitting light. Each of the first and second retardation films 36 and 37 may include a laminate of a λ/4 retardation film and a λ/2 retardation film.

An optical compensating film may be further arranged on either or both of the first and second polarizers 36 and 37. The use of the optical compensating film further improves contrast. The optical compensating film includes a negative uniaxial median composed of hybrid-aligned discotic liquid crystal molecules having negative anisotropy of refractive index or a positive uniaxial medium composed of hybrid-aligned nematic liquid crystal molecules having positive anisotropy of refractive index. Alternatively, the negative uniaxial medium and the positive uniaxial medium may be used in combination. A biaxial medium having refractive indices in directions of nx>ny>nz may be used.

The initial transition operation of the liquid crystal display device 100 in the OCB mode will now be described with reference to the drawings. FIGS. 5A and 5B are diagrams explaining alignment states of liquid crystal molecules in the OCB mode.

In the initial state (inoperative state) of the liquid crystal display device in the OCB mode, the liquid crystal molecules 51 are aligned such that the molecules are splayed as shown in FIG. 5B. This alignment is called splay alignment. During the display operation, the liquid crystal molecules 51 are aligned so as to form arches as shown in FIG. 5A. This alignment is termed bend alignment. The liquid crystal display device 100 changes the transmittance by controlling the degree of curving the arches in the bend alignment during the display operation to realize a high response speed in the display operation.

In the liquid crystal display device 100 in the OCB mode, the alignment state of the liquid crystal molecules in the inoperative state is the splay alignment of FIG. 5B. It is therefore necessary to perform the initial transition operation by applying a voltage at or above a threshold level to the liquid crystal layer 50 upon power-on to cause transition from the initial splay alignment shown in FIG. 5B to the bend alignment, shown in FIG. 5A, in the display operation. If the initial transition is insufficient, a display defect may occur, alternatively, a desired high response speed may not be obtained. For the initial transition operation for the liquid crystal layer 50, a method of applying a pulsed voltage between the pixel electrode 9 and the common electrode 25 while line-sequentially turning on the scan lines 3a may be used.

In the liquid crystal display device 100 according to the first embodiment, the sub-reflective-display areas R, in each of which the thickness of the liquid crystal layer 50 is thinner than that in the transmissive display area T, are arranged on both the ends of each sub-pixel region along the lengthwise direction thereof. In other words, the reflecting electrodes 19a and 19b are arranged near the scan lines 3a disposed so as to sandwich the pixel electrode 9 and the transmissive display area T which the thickness of the liquid crystal layer is thicker than that in the reflective display area is arranged in the middle of the sub-pixel region. Since the areas having the thin thickness of the liquid crystal layer are arranged near the scan lines 3a, the liquid crystal display device 10 according to the first embodiment can perform the initial transition operation with a low voltage in a short time.

When a voltage V is applied between the pixel electrode 9 and the common electrode 25 in order to perform the initial transition operation, an electric field Er (=V/dr) affecting the liquid crystal layer 50 in each sub-reflective-display area R, in which the thickness dr is approximately half the thickness dt in the transmissive display area T, is larger than an electric field Et (=V/dt) affecting the liquid crystal layer 50 in the transmissive display area T. Accordingly, an initial transition nucleus (bend alignment nucleus) is easily generated. Furthermore, the generated initial transition nucleus is smoothly propagated.

In each sub-pixel region in accordance with the first embodiment, each sub-reflective-display area R is arranged near both of the border between the scan line 3a and the pixel electrode 9 and the border between the data line 6a and the pixel electrode 9, each border serving as an area where the initial transition nucleus is generated. Therefore, the initial transition nuclei generated in those borders can be smoothly introduced into the sub-reflective-display areas R. Further, the initial transition nuclei are efficiently propagated above the pixel electrode 9 in the sub-reflective-display areas R. Consequently, the initial transition can be advanced in the entire sub-pixel region without unevenness.

Since the liquid crystal display device 100 according to the first embodiment efficiently performs the initial transition operation using the characteristics of the sub-reflective-display areas R as described above, it is unnecessary to provide projections, depressions, and electrode slits as known transition-nucleus generators. Therefore, a reduction in aperture ratio caused by arrangement of those transition-nucleus generators does not occur. Advantageously, bright display can be achieved.

In the liquid crystal display device 100 according to the first embodiment, the layer-thickness adjusting layer 26 is arranged above the base 21 (of the opposite substrate 20) adjacent to the liquid crystal layer 50. The layer-thickness adjusting layer 96 may be arranged above the base 11 (of the device substrate 10) adjacent to the liquid crystal layer 50. The layer-thickness adjusting layer 26 may be disposed in each of the device substrate 10 and the opposite substrate 20.

Since the layer-thickness adjusting layer 26 is arranged in not the device substrate 10 but the opposite substrate 20 in accordance with the first embodiment, the distance between the liquid crystal layer 50 and each of the scan lines 3a and the data lines 6a is short. Accordingly, initial transition nuclei may be easily generated in the vicinities of the scan lines 3a and the data lines 6a during the initial transition operation. This arrangement is, therefore, effective in reducing an applied voltage for the initial transition operation and in uniformly advancing the initial transition, operation in a short time,

In the first embodiment, the spacer 40 is disposed in the reflective display area R in each sub-pixel region as shown in FIG. 3. The liquid crystal molecules 51 tend to be aligned in random directions in the vicinity of the spacer 40, so that an initial transition nucleus is easily generated. Accordingly, each spacer 40 also functions as a transition-nucleus generator in the liquid crystal display device 100. The arrangement of the spacer 40 in the reflective display area R leads to smooth propagation of an initial transition nucleus generated by the spacer 40. Advantageously, the initial transition operation can be performed more rapidly with higher reliability.

### Second Embodiment

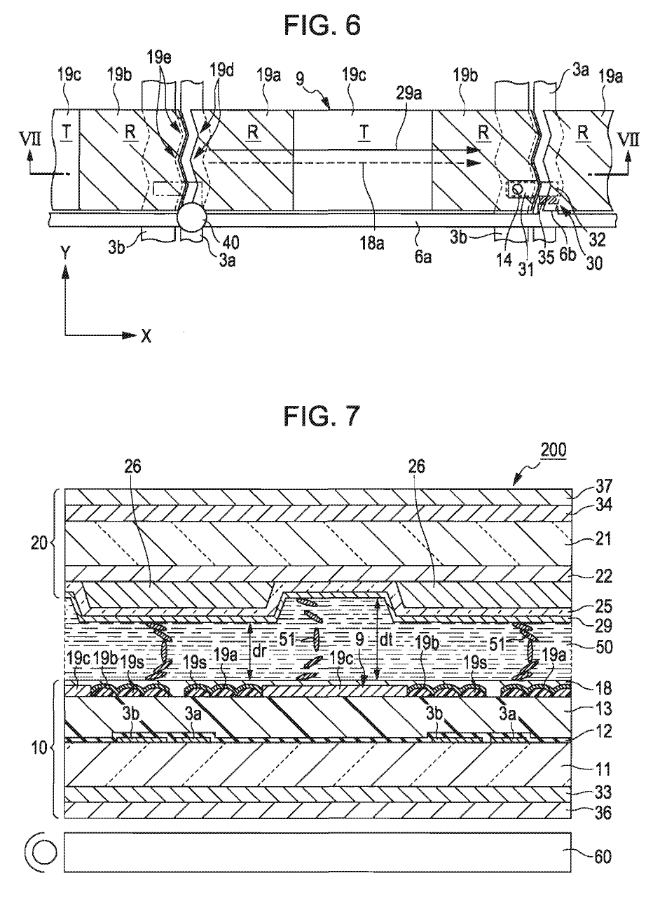

A second embodiment of the invention will now be described with reference to FIGS. 6 and 7.

FIG. 6 is a schematic plan view of sub-pixel regions of a liquid crystal display device 200 according to the second embodiment. FIG. 7 is a cross-sectional view of the liquid crystal display device 200 taken along the line VII-VII of FIG. 6.

The liquid crystal display device 200 according to the second embodiment has the same structure as that in the foregoing first embodiment, except that the shape of each pixel electrode and areas where a layer-thickness adjusting layer is arranged are different from those of the first embodiment. Accordingly, the same components as those in the first embodiment are designated by the same reference numerals in FIGS. 6 and 7 and a detailed description of the previously described components is omitted.

Referring to FIG. 6, in each sub-pixel region of the liquid crystal display device 200 according to the second embodiment, the pixel electrode 9 including the reflecting electrodes 19a and 19b and the transparent electrode 19c, the TFT 30, and the signal lines (the scan line 3a, the capacitor line 3b, and the data line 6a) are arranged. In the second embodiment, each short side (extending In substantially the Y-axis direction) of each pixel electrode 9 is zigzag. Specifically, the outer edge of each reflecting electrode 19a is the inverse of that of the reflecting electrode 19b so that the neighboring pixel electrodes 9 are engaged with each other. The scan lines 3a and the capacitor lines 3b each have similar zigzag portions so as to fit to the short sides of the respective pixel electrodes 9.

Referring to FIG. 7, the layer-thickness adjusting layer 26 for reducing the thickness dr of the liquid crystal layer 50 In each reflective display area R to half the thickness dt of the liquid crystal layer 50 in each transmission display area T is arranged in the opposite substrate 20 adjacent to the liquid crystal layer 50. In the second embodiment, the layer-thickness adjusting layer 26 is disposed so as to extend above the sub-reflective-display areas R of two neighboring sub-pixel regions arranged in the extending direction of the data line 6a (the X-axis direction). In other words, the thickness of the liquid crystal layer 50 in a portion, where the scan line 3a is arranged, between the neighboring sub-pixel regions arranged in the extending direction of the data line 6a is the same as the thickness dr in each reflective display area R.

In the liquid crystal display device 200 with the above-described structure according to the second embodiment, the short sides of each pixel electrode 9 are zigzag. Consequently, a transverse electric field (toward the surface of the substrate) generated between each pixel electrode 9 and the corresponding scan line 3a during the initial transition operation is applied in different directions at each zigzag short side of the pixel electrode 9. The electric fields affect the liquid crystal layer 50, thus causing disclinations in angles 19d and 19e of the zigzag short sides of the respective pixel electrodes 9. Those disclinations become initial transition nuclei. The short sides of the respective pixel electrodes 9, therefore, function as transition-nucleus generators in the liquid crystal display device 200 according to the second embodiment.

The transverse electric fields are orthogonal to the short sides of the respective pixel electrodes 9 and intersect the alignment directions 18a and 29a. Consequently, the liquid crystal molecules 51 located in the vicinities of the short sides of the respective pixel electrodes 9 are twisted, thus easily causing transition to bend alignment. According to the second embodiment, therefore, a plurality of initial transition nuclei can be generated in the border between each pixel electrode 9 and the corresponding scan line 3a. Advantageously, initial transition can be smoothly propagated rapidly.

In the second embodiment, the thickness of the liquid crystal layer in each portion between the neighboring sub-pixel regions is equal to the thickness dr in each reflective display area R and is approximately half the thickness dt in each transmissive display area T. In each portion between the neighboring sub-pixels, therefore, initial transition nuclei are easily generated in the liquid crystal layer 50 in each portion between neighboring sub-pixels and the initial transition nuclei are easily propagated. Accordingly, the initial transition nuclei can be very easily generated during the initial transition operation, thus achieving the rapid initial transition operation.

### Third Embodiment

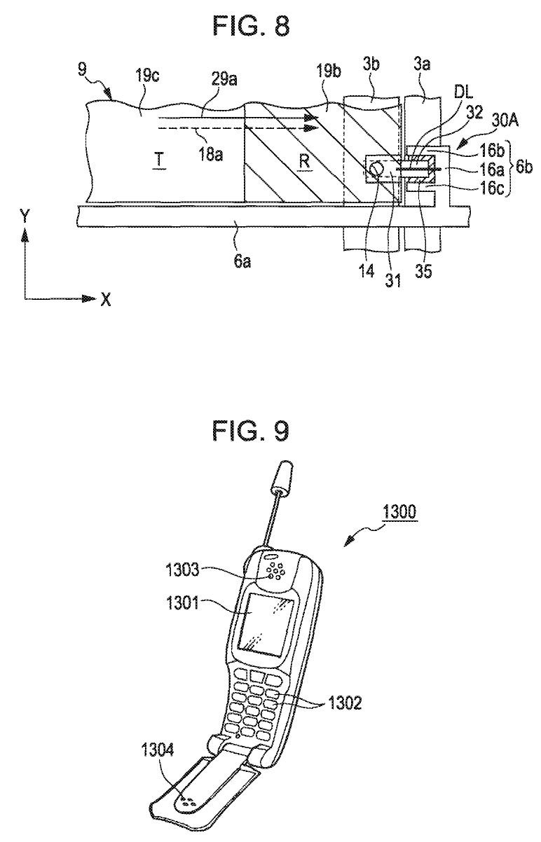

A third embodiment of the invention will now be described with reference to FIG. 8.

FIG. 8 is a plan view of part of a single sub-pixel region of a liquid crystal display device according to a third embodiment of the invention.

The liquid crystal display device according to the third embodiment includes TFTs 30a having a double source structure as pixel switching elements. This structure according to the third embodiment can be combined with either of the structures according to the first and second embodiments.

Referring to FIG. 8 the TFT 30A is electrically connected to the pixel electrode 9 in each sub-pixel region of the liquid crystal display device according to the third embodiment. The TFT 30A includes the island-shaped semiconductor layer 35, the source electrode 6b connected to the semiconductor layer 35, and the drain electrode 32. The source electrode 6b includes an interconnecting segment 16a extending from the data line 6a in parallel to the scan line 3a, a first electrode segment 16b, and a second electrode segment 16c, the first and second electrode segments extending from the interconnecting segment 16a over the semiconductor layer 35. The TFT 30A has the double source structure in which the first and second electrode segments 16b and 16c each function as the source electrode of the TFT 30A.

In the TFT 30A with the above-described structure, the first and second electrode segments 16b and 16c are disposed on both sides of the drain electrode 32 in the Y-axis direction in which the scan line 3a extends linen the TFT 30A is operated upon initial transition operation, an electric field applied from the drain electrode 32 to the first electrode segment 16b and another electric field applied from the drain electrode 32 to the second electrode segment 16c are generated above the TFT 30A, so that the generated electric fields affect the liquid crystal layer 50. Those electric fields are opposite to each other in the direction along the surface of the substrate. Consequently, a disclination line DL is generated in the middle of the drain electrode 32 in the width direction thereof (the Y-axis direction. The disclination line DL serves as an initial transition nucleus, thus expanding initial transition. In the liquid crystal display according to the third embodiment, therefore, each TFT 30A functions as a transition-nucleus generator in the initial transition operation.

Since the electric fields generated above the TFT 30A intersect the direction (alignment directions 18a and 29a) of initial alignment of liquid crystal molecules, the liquid crystal molecules are twisted above the TFT 30A, thus easily causing alignment transition. In the liquid crystal display device according to the third embodiment, an initial transition nucleus can be reliably generated above each TFT 30A and the initial transition nucleus can be smoothly propagated. Advantageously, the initial transition operation can be rapidly achieved with a low voltage.

The above-described arrangements that help to generate an initial transition nucleus in the first to third embodiments have been described as some examples. The arrangements may be used in combination with another transition-nucleus generator. For example, in the liquid crystal display device 100 according to the first embodiment, a protrusion, a depression, and/or an electrode slit may be arranged as a transition-nucleus generator in each sub-pixel region or each portion between neighboring sub-pixel regions. In this case, it is preferred that the protrusion or depression be disposed above the scan line 3a or the data line 6a in the vicinity of the reflective display area R. When the electrode slit is arranged in each pixel electrode 9, it is preferred that the electrode slit be arranged in each of the reflecting electrodes 19a and 19b, each serving as the sub-reflective-display areas R.

In the first to third embodiments, a portion (slope 70) on which the thickness of the liquid crystal layer gradually varies due to the layer-thickness adjusting layer 26 is arranged above the border between each reflective display area R and the transmissive display area T. The protrusion, depression, and/or the electrode slit may be arranged in the slope 70.

An electrode for generating an initial transition nucleus may be arranged as a transition-nucleus generator. In this case, preferably, a potential-controllable electrode is arranged above the scan line 3a or the data line 6a in each portion between neighboring pixel electrodes 9. More preferably, the electrode is disposed near the reflective display area R. Alternatively, a potential-controllable electrode may be arranged in an area above the slope 70 independently of the pixel electrode 9.

Alternatively, a plurality of liquid crystal domains having different alignment states may be arranged in each sub-pixel region and a portion surrounding the sub-pixel region. In this case, at least one of the alignment layers 18 and 29 is subjected to multi-rubbing, alternatively, at least one of them is allowed to include a plurality of alignment layer segments arranged two-dimensionally, thus realizing the liquid crystal domains having different alignment states. For example, the alignment layers 18 and 19 located outside the area corresponding to each pixel electrode 9 (i.e., in each portion between sub-pixels) are rubbed in the direction intersecting the alignment directions 18a and 29a, so that the alignment state of liquid crystal above the pixel electrode 9 is made different from that outside the area corresponding to the pixel electrode 9. Alternatively, an alignment layer for aligning liquid crystal molecules in the direction normal to the substrate may be selectively arranged in the portions between the sub-pixels. In those cases, the liquid crystal domain having a different alignment state from that of the liquid crystal domain above each pixel electrode 9 functions as a transition-nucleus generator

In each of the embodiments, the sub-reflective-display areas R are arranged in both the ends of each sub-pixel region. According to the invention, the transmissive display area T may be disposed between the sub-reflective-display areas R in each sub-pixel region. The arrangement of the transmissive display area and the sub-reflective-display areas is not limited to that in each embodiment. For example, the sub-reflective-display area R may be arranged like a frame along the periphery of each sub-pixel region and the transmissive display area T may be arranged within the frame-shaped reflective display area R. Specifically, in the sub-pixel region in FIG. 3, the sub-reflective-display areas R may be arranged between the transmissive display area T and the data lines 6a (i.e., on both the ends of the transmissive display area T in the Y-axis direction). In this case, only the sub-reflective-display areas R in which the thickness of the liquid crystal layer is thin are arranged near the scan lines 3a and the data lines 6a where initial-transition nuclei are generated, thus further promoting the generation of initial-transition nuclei and more smoothly propagating initial transition.

### Electronic Apparatus

The liquid crystal display device according to any of the embodiments of the invention may be used as, for example, a display unit 1301 of a mobile phone 1300 as shown in FIG. 9. The mobile phone 1300 includes, in its casing, a plurality of operation buttons 1302, an earpiece 1303, and a mouthpiece 1304 in addition to the display unit 1302.

In the mobile phone 1300, the initial transition operation can be reliably performed in a short time. Advantageously, rapid response display without any display defect can be achieved.

The electronic apparatus including the liquid crystal display device according to any of the embodiments of the invention is not limited to the above-described mobile phone. The display device in accordance with each of the embodiments of the invention may be suitably used as a display unit of an electronic apparatus, e.g., a personal digital assistant (PDA), a personal computer, a notebook-size personal computer, a workstation, a digital still camera, an on-vehicle monitor, a car navigation system, a head-up display, a digital video camera, a television receiver, a view-finder type or monitor-direct-view type video tape recorder, a pager, an electronic organizer, an electronic calculator, an electronic book, a projector, a word processor, a videophone, a POS terminal, an apparatus having a touch panel, or a lighting system.

What is claimed is:

1. A liquid crystal display device that performs initial transition before display operation from splay alignment of liquid crystal to bend alignment, the device comprising:
a first substrate and a second substrate; and
a liquid crystal layer between the first and the second substrates, wherein
a transmissive display area, a first sub-reflective-display area and a second sub-reflective-display area are arranged in each sub-pixel region,
the first sub-reflective-display area and the second sub-reflective-display area form reflective display area,
the thickness of the liquid crystal layer in the transmissive display area is made different from that in the reflective display area, and
the transmissive display area is disposed between the first sub-reflective-display area and the second sub-reflective-display area.

2. The device according to claim 1, further comprising:
a layer-thickness adjusting layer for adjusting the thickness of the liquid crystal layer, the layer-thickness adjusting layer being arranged in at least one of the first and second substrates adjacent to the liquid crystal layer such that the layer-thickness adjusting layer extends above the reflective display area of two neighboring sub-pixel regions.

3. The device according to claim 1, wherein one of the first and second substrates includes signal lines electrically connected to switching elements so as to correspond to the respective sub-pixel regions, and
the other substrate includes a layer-thickness adjusting layer for adjusting the thickness of the liquid crystal layer such that the layer-thickness adjusting layer is arranged adjacent to the liquid crystal layer.

4. The device according to claim 1, wherein the first sub-reflective-display area is arranged in one end of the sub-pixel region in the lengthwise direction thereof, and
the second sub-reflective-display area is arranged in another end of the sub-pixel region which is opposite to the one end of the sub-pixel region.

5. The device according to claim 1, further comprising:
a transition-nucleus generating mechanism arranged in the reflective display area.

6. The device according to claim 1, further comprising:
a transition-nucleus generating mechanism arranged in a portion between the reflective display area and the transmissive display area.

7. The device according to claim 1, further comprising:
a transition-nucleus generating mechanism arranged in a portion between neighboring sub-pixel regions.

8. The device according to claim 5, wherein the transition-nucleus generating mechanism is a signal line electrically connected to a switching element arranged so as to correspond to the sub-pixel region, or an electrode disposed so as to correspond to the sub-pixel region.

9. The device according to claim 5, wherein the transition-nucleus generating mechanism is a domain, where the alignment state of liquid crystal is made different from that in the sub-pixel, in the liquid crystal layer.

10. The device according to claim 9, wherein in the domain having the different alignment state, liquid crystal molecules in the liquid crystal layer are aligned in homeotropic alignment.

11. The device according to claim 9, wherein in the domain having the different alignment state, liquid crystal molecules in the liquid crystal layer are aligned in twisted

12. The device according to claim 5, wherein the transition-nucleus generating mechanism is a spacer for maintaining the spacing between the first and the second substrates.

13. An electronic apparatus including the liquid crystal display device according to claim 1.
